(19) United States
(12) Patent Application Publication
(10) Pub. No.: US 2016/0363846 A1
(43) Pub. Date: Dec. 15, 2016

(54) LIGHT SOURCE DEVICE, ILLUMINATION DEVICE, AND PROJECTOR

(71) Applicant: Seiko Epson Corporation, Tokyo (JP)

(72) Inventors: Takahiro Takizawa, Suzaka-shi (JP); Daiki Yuto, Matsumoto-shi (JP)

(21) Appl. No.: 15/173,986

(22) Filed: Jun. 6, 2016

(30) Foreign Application Priority Data
Jun. 11, 2015 (JP) 2015-118090

(51) Int. Cl. G03B 21/16; G03B 21/00; G03B 21/20

(52) U.S. Cl. CPC G03B 21/16; G03B 21/2013; G03B 21/005

(57) ABSTRACT

A light source device includes a light emitting tube including a light emitting part, a reflector adapted to reflect light emitted from the light emitting tube, a housing body adapted to house the light emitting tube and the reflector, and a plurality of inlet ports adapted to guide a cooling gas to the light emitting tube from respective directions different from each other.

### CROSS REFERENCE TO RELATED APPLICATION

The entire disclosure of Japanese Patent Application No.2015-118090, filed Jun. 11, 2015 is expressly incorporated by reference herein.

### BACKGROUND

1. Technical Field

The present invention relates to a light source device, an illumination device, and a projector.

2. Related Art

In the past, there has been known a projector provided with an illumination device, a light modulation device for modulating the light emitted from the illumination device to thereby form an image corresponding to image information, and a projection optical device for projecting the image on a target projection surface such as a screen in an enlarged manner.

As such a projector, there has been known a projector equipped with a light source device for making a cooling position of a light source lamp different in accordance with the posture of the projector (see, e.g., JP-A-2010-38976 (Document 1)).

The light source device of the projector described in Document 1 is provided with a light source lamp, and a housing body, which the light source lamp is housed inside. The housing body is provided with a pair of opening parts, a duct part having an inlet port on the opposite side to the pair of opening parts, and a current guide member rotating under its own weight, and due to the rotation of the current guide member under its own weight, a cooling air is made to flow through either one of the pair of opening parts via the duct part.

Incidentally, since the light source device described in Document 1 has the current guide member described above disposed in the housing body for housing the light source lamp, there is a problem that the light source device grows in size. Therefore, it is necessary to increase the space for installing the light source device in the projector. Further, in the projector provided with a plurality of such light devices, since it is necessary to further increase the space, and further, the light source devices as replacement parts are large in size, there is a problem that it becomes cumbersome to install the light source devices to the projector.

### SUMMARY

An advantage of some aspects of the invention is to provide a light source device, and illumination device, and a projector, which can be miniaturized.

A light source device according to a first aspect of the invention includes a light emitting tube including a light emitting part, a reflector adapted to reflect light emitted from the light emitting tube, a housing body adapted to house the light emitting tube and the reflector, and a plurality of inlet ports adapted to guide a cooling gas to the light emitting tube from respective directions different from each other.

According to the first aspect of the invention described above, since the cooling gas can be supplied inside the housing body in which the light emitting tube is housed in the directions different from each other, it is possible to cool the light emitting tube with the cooling gas from the directions different from each other. Further, since the light source device is not provided with the flow dividing device for dividing the cooling gas flowing into either of the inlet ports, the light source device can be miniaturized.

In the first aspect of the invention, it is preferable that the housing body includes a first housing adapted to house the light emitting tube and the reflector, and a second housing provided with the plurality of inlet ports, and the inlet ports are disposed in a surface perpendicular to a central axis of a light beam emitted from the light source device so that a position of one of the inlet ports and a position of adjacent one of the inlet ports are 90° different from each other around the central axis.

Here, the upper side of the light emitting tube is apt to be heated by the light emission compared to the lower side, and therefore, the temperature difference occurs between the upper side and the lower side. Such a localized temperature difference causes deterioration such as clouding or deformation of the glass constituting the light emitting tube, and becomes a factor for shortening the life of the light emitting tube. In contrast, according to the first aspect of the invention described above, since the cooling gas can be supplied to the upper side of the light emitting tube even in the case in which the posture of the light source device changed as much as 90°, the light emitting tube can effectively be cooled.

In the first aspect of the invention, it is preferable that the second housing includes a plurality of duct parts respectively connected to the inlet ports, and end parts of the duct parts located on an opposite side to a side to which the inlet ports are connected are arranged in a direction perpendicular to the central axis of the light beam.

According to the first aspect of the invention described above, since the end parts of the duct parts connected to the inlet ports are arranged in the direction described above, for example, the cooling gas to be supplied to the inlet ports can be supplied from one direction. Therefore, compared to the case in which the end parts of the duct parts are arranged in two or more directions, the cooling gas can efficiently be supplied, and at the same time, the light source device can be miniaturized.

In the first aspect of the invention, it is preferable that at least one of the duct parts includes a current guide part adapted to guide the cooling gas, and a bent part connected to the current guide part, and bending in a direction different from the current guide part, and the current guide part and the bent part guide the cooling gas to at least either one of a reflecting surface of the reflector and a tip part of the light emitting tube.

According to the first aspect of the invention described above, in the case in which the cooling gas is guided to the reflecting surface of the reflector by the current guide part and the bent part provided to the duct part, the possibility for the cooling gas to be supplied to the light emitting part of the light emitting tube along the reflecting surface of the reflector is raised.

Further, since there is a high possibility that a lead wire is wound around the tip part of the light emitting tube, the temperature of the tip part is apt to rise. In contrast, since in the first aspect of the invention, the cooling gas is guided to the tip part described above, the tip part can efficiently be cooled. Therefore, the cooling efficiency of the light source device can be improved.

In the first aspect of the invention, it is preferable that at least one of the inlet ports has a wind guide part adapted to guide the cooling gas to a reflecting surface of the reflector.

According to the first aspect of the invention described above, since the cooling gas is guided by the wind guide part to the reflecting surface of the reflector, it is possible to supply the cooling gas to the light emitting part of the light emitting tube along the reflecting surface of the reflector. Thus, the cooling efficiency of the light source device can be improved.

An illumination device according to a second aspect of the invention includes a light source device described above, and a holding member adapted to hold the light source device, and the holding member has a flow dividing device adapted to guide the cooling gas to at least one of the inlet ports.

According to the second aspect of the invention described above, substantially the same advantages as those of the light source device according to the first aspect of the invention described above can be exerted. Further, since the holding member is provided with the flow dividing device, the light source device can surely be miniaturized, and furthermore, the illumination device can be miniaturized compared to the case in which the flow dividing device is provided to the light source device. Further, since the cooling gas can selectively be supplied to a desired inlet port by the flow dividing device, the cooling gas can surely be supplied to the upper part of the light emitting tube described above in accordance with, for example, the posture of the illumination device. Therefore, the upper part of the light emitting tube of the light source device can surely be cooled.

A projector according to a third aspect of the invention includes an illumination device described above, a light modulation device adapted to modulate light emitted from the illumination device, a projection optical device adapted to project image based on the light modulated by the light modulation device, and a cooling device adapted to supply the cooling gas.

According to the third aspect of the invention described above, substantially the same advantages as those of the light source device according to the first aspect of the invention described above and the illumination device according to the second aspect of the invention described above can be exerted. Further, since the light source can be made smaller due to the illumination device described above, the illumination device equipped with the light source device, and furthermore the projector can be miniaturized. Further, since the light source device can be miniaturized, the replacement operation and so on of the light source device can be made easy.

### BRIEF DESCRIPTION OF THE DRAWINGS

The invention will be described with reference to the accompanying drawings, wherein like numbers reference like elements.

FIG. 1 is a schematic perspective view showing a projector according to an embodiment of the invention.

FIG. 2 is a schematic diagram showing an internal configuration of the projector according to the embodiment described above.

FIG. 3 is a perspective view showing an illumination device according to the embodiment described above.

FIG. 4 is a plan view of the illumination device according to the embodiment described above.

FIG. 5 is a perspective view showing a first lamp unit according to the embodiment described above.

FIG. 6 is a perspective view showing the first lamp unit according to the embodiment described above in the state in which the light source device is removed.

FIG. 7 is a perspective view showing a flow dividing device according to the embodiment described above.

FIG. 8 is a perspective view showing the flow dividing device according to the embodiment described above.

FIG. 9 is an exploded perspective view showing the flow dividing device according to the embodiment described above.

FIG. 10 is a front view showing the flow dividing device in the case in which the projector according to the embodiment described above is in a normal mounting posture.

FIG. 11 is a cross-sectional view showing the flow dividing device according to the embodiment described above.

FIG. 12 is a diagram showing flow channels of a cooling gas flowing through the flow dividing device according to the embodiment described above.

FIG. 13 is a diagram showing the flow channels of the cooling gas flowing through the flow dividing device according to the embodiment described above.

FIG. 14 is a diagram showing the flow channels of the cooling gas flowing through the flow dividing device according to the embodiment described above.

FIG. 15 is a perspective view showing the light source device according to the embodiment described above.

FIG. 16 is a perspective view showing the light source device according to the embodiment described above in the state in which a wind guide member is removed.

FIG. 17 is a perspective view showing the wind guide member according to the embodiment described above.

FIG. 18 is a cross-sectional view showing a cross-sectional surface of the light source device according to the embodiment described above.

FIG. 19 is a cross-sectional view showing a cross-sectional surface of the light source device according to the embodiment described above.

FIG. 20 is a plan view showing a state in which the flow dividing device and the light source device according to the embodiment described above are connected to each other.

FIG. 21 is a cross-sectional view showing a cross-sectional surface of the flow dividing device and the light source device according to the embodiment described above.

### DESCRIPTION OF AN EXEMPLARY EMBODIMENT

An embodiment of the invention will hereinafter be described with reference to the accompanying drawings.

### Appearance Configuration of Projector

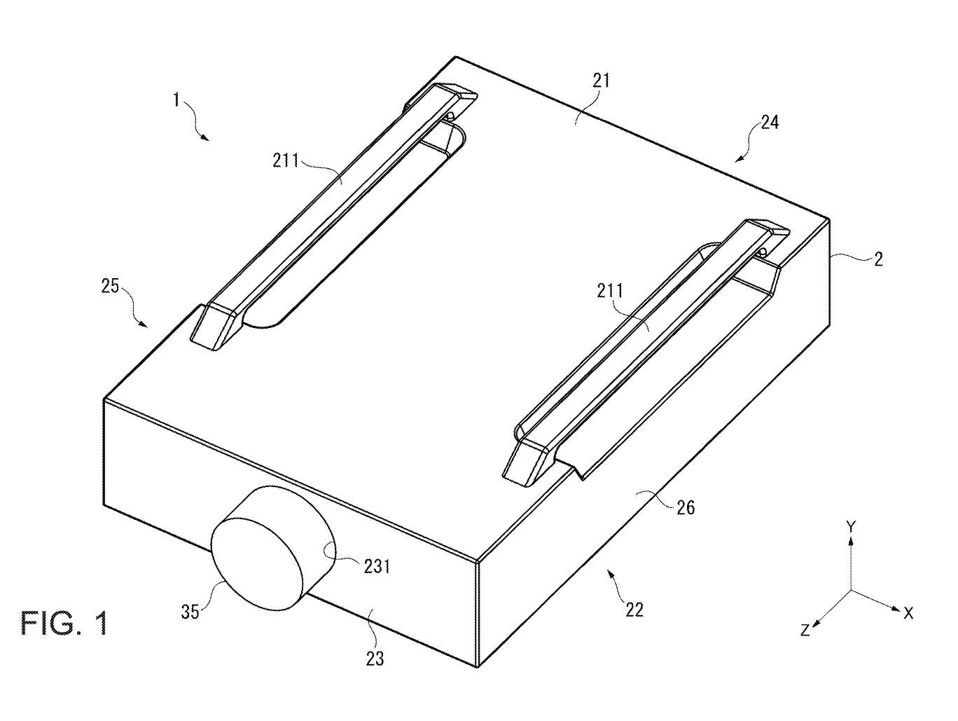

FIG. 1 is a schematic perspective view showing a projector 1 according to the present embodiment.

The projector 1 according to the present embodiment is a projection display device for modulating the light emitted from an illumination device 31 described later to thereby form an image corresponding to image information, and then projecting the image on a projection target surface such as a screen in an enlarged manner.

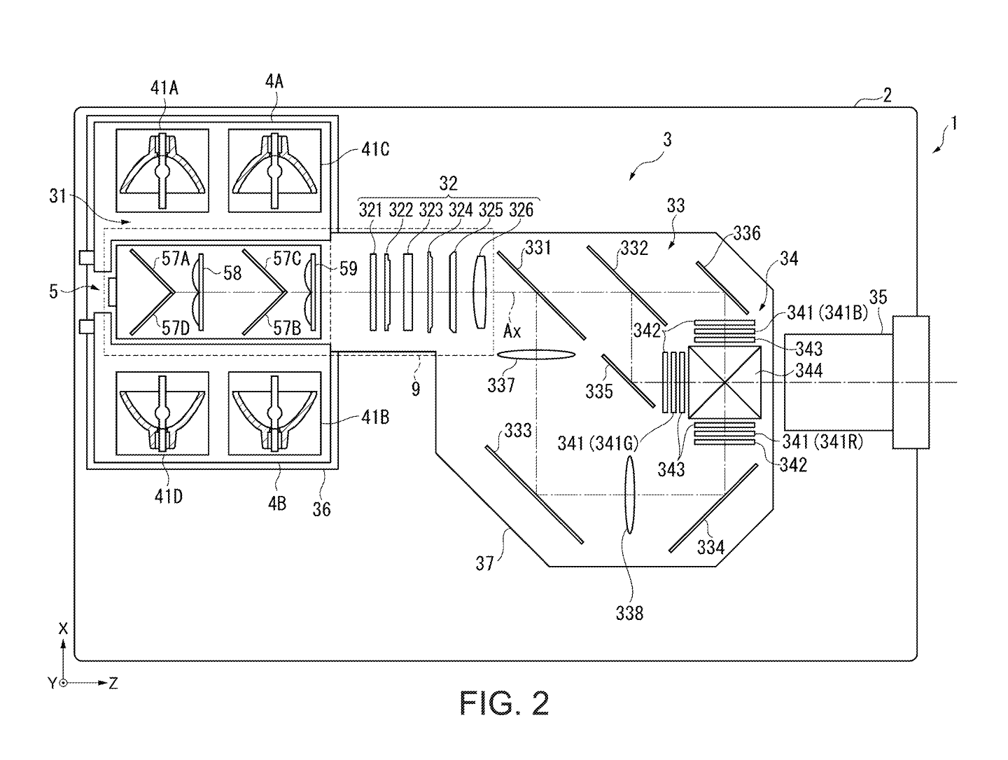

The projector 1 is a multi-lamp type projector provided with four light source devices 41A through 41D (see FIG. 2). The light emitted from the four light source devices 41A through 41D is reflected by a light path changing device 5 in the same direction, then emitted from an illumination device 31, and then enters a light modulation device via a plurality of optical components although described later in detail.

An exterior housing 2 is formed to have a roughly rectangular solid shape having a top surface part 21, a bottom surface part 22, a front surface part 23, a back surface part 24, a left side surface part 25, and a right side surface part 26.

The top surface part 21 is provided with a pair of grip parts 211 used when the user grips the projector 1, or when the projector 1 is fixed to the equipment installed on the ceiling or the like.

Although not shown in the drawings, the bottom surface part 22 is provided with a leg part, which has contact with an installation surface of an installation stand or the like when the projector 1 is mounted on the installation surface.

The front surface part 23 is provided with an opening part 231 from which a part of a projection optical device 35 constituting an image forming device 3 described later is exposed.

The back surface part 24 is provided with an opening part (not shown) for housing a first lamp unit 4A, a second lamp unit 4B (see FIG. 2), and the light path changing device 5 (see FIG. 2) in the exterior housing 2 in an replaceable manner, and the opening part is covered with a cover member (not shown).

Although not shown in the drawings, besides the above, the right side surface part 26 is provided with an inlet port for introducing an air located in the outside of the exterior housing 2 to the inside, and the left side surface part 25 is provided with an exhaust port for discharging the air located in the inside of the exterior housing 2 to the outside.

It should be noted that in the following description, an emission direction of the light by the illumination device 31 is defined as a Z direction, and directions, which are perpendicular to the Z direction, and are perpendicular to each other, are defined as an X direction and a Y direction, respectively. In the present embodiment, since the Z direction is a direction from the back surface part 24 toward the front surface part 23, the explanation will be presented assuming that the X direction is a direction from the left side surface part 25 toward the right side surface part 26, and the Y direction is a direction from the bottom surface part 22 toward the top surface part 21.

### Internal Configuration of Projector

FIG. 2 is a schematic diagram showing an internal configuration of the projector 1.

As shown in FIG. 2, the projector 1 is provided with the image forming device 3 and a cooling device 9 for cooling components of the projector 1 disposed inside the exterior housing 2 in addition to the exterior housing 2 described above. Besides the above, although not shown in the drawings, the projector 1 is provided with a control device for controlling the projector 1, and a power supply device for supplying electronic components constituting the projector 1 with electrical power.

### Configuration of Image Forming Device

The image forming device 3 forms and then projects the image corresponding to the image information input from the control device described above. The image forming device 3 is provided with an illumination device 31, a homogenization device 32, a color separation device 33, an electro-optic device 34, a projection optical device 35, a base member 36, and an optical component housing 37.

Among these devices, the base member 36 to be connected to the optical component housing 37 has a function of housing and fixing the illumination device 31.

Further, the optical component housing 37 is a box-like housing having the illumination optical axis Ax set inside, and the homogenization device 32 and the color separation device 33 are disposed at respective positions on the illumination optical axis Ax in the inside of the optical component housing 37. Further, the illumination device 31, the electro-optic device 34, and the projection optical device 35 are located outside the optical component housing 37, but are disposed in accordance with the illumination optical axis Ax.

The illumination device 31 emits parallel light to the homogenization device 32. The configuration of the illumination device 31 will be described later in detail.

The homogenization device 32 homogenizes the illuminance in a plane perpendicular to the central axis of the light beam emitted from the illumination device 31. The homogenization device 32 has a cinema filter 321, a first lens array 322, a UV filter 323, a second lens array 324, a polarization conversion element 325, and an overlapping lens 326.

Among these components, the polarization conversion element 325 is for uniforming the polarization direction of the light having entered the polarization conversion element 325 into one type.

The color separation device 33 separates the light beam input from the homogenization device 32 into three colored light beams of red (R), green (G), and blue (B). The color separation device 33 has dichroic mirrors 331, 332, reflecting mirrors 333 through 336, and relay lenses 337, 338.

The electro-optic device 34 modulates each of the colored light beams, which have been separated into, in accordance with the image information, and then combines the colored light beams, which have been modulated, with each other. The electro-optic device 34 has a liquid crystal panel 341 (the liquid crystal panels for red, green, and blue are denoted by 341R, 341G, and 341B, respectively), an incident side polarization plate 342, and an exit side polarization plate 343 as a light modulation device disposed for each of the colored light beams, and a single color combining device 344. Among these components, as the color combining device 344, there can be adopted a dichroic prism.

The projection optical device 35 is a projection lens for projecting the light beam (the light beam for forming an image) combined by the color combining device 344 on the projection target surface described above in an enlarged manner. As such a projection optical device 35, there can be adopted a combination lens having a plurality of lenses arranged in a lens tube.

### Configuration of Illumination Device

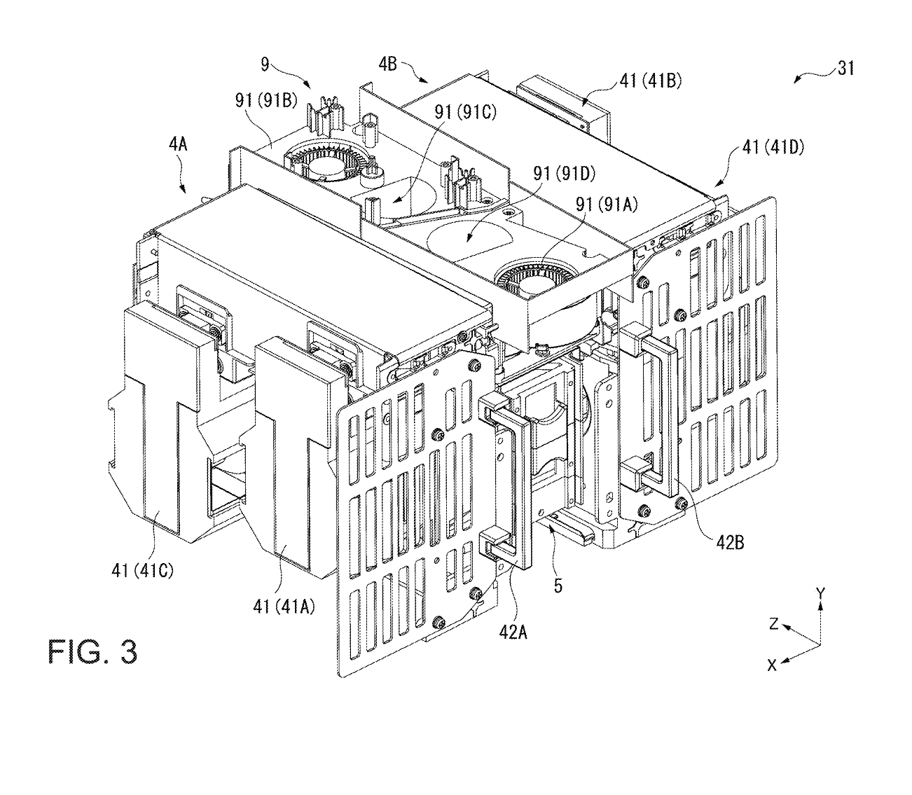

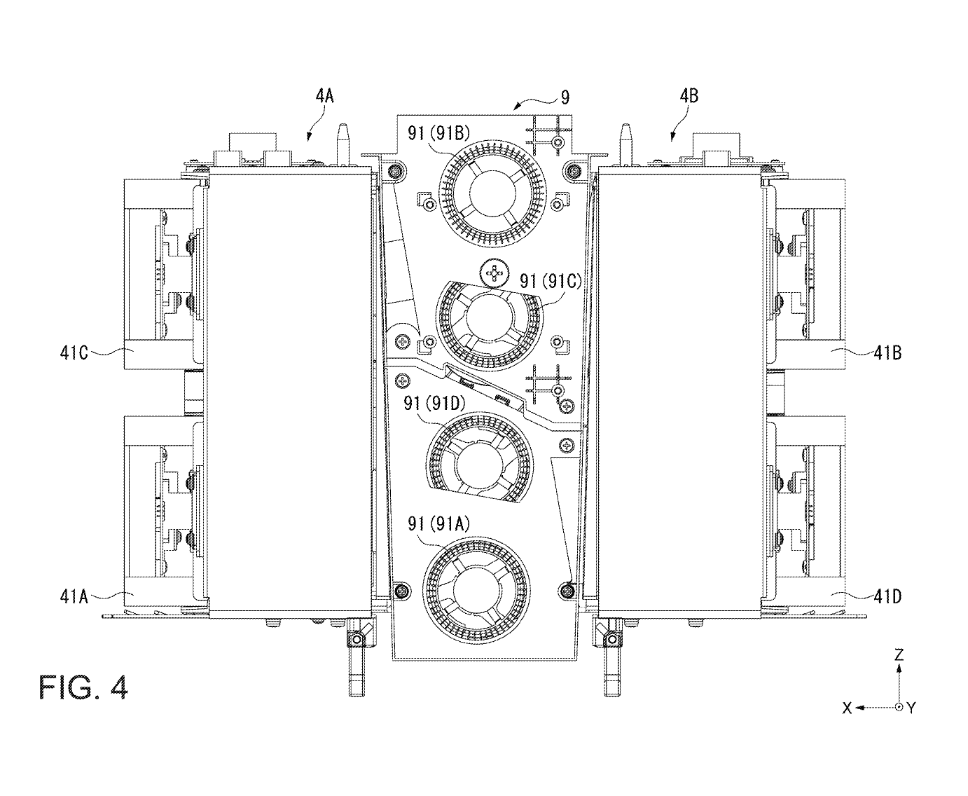

FIG. 3 is a perspective view of the illumination device 31 viewed from an opposite-direction side to the Z direction, and FIG. 4 is a plan view of the illumination device 31 viewed from the Y direction.

As shown in FIG. 2 through FIG. 4, the illumination device 31 has the four light source devices 41 (41A through 41D) fixed to a first lamp unit 4A and a second lamp unit 4B. Besides the above, the illumination device 31 is provided with the light path changing device 5 for reflecting the light beams having been emitted from the respective light source devices 41A through 41D toward the same direction to uniform the directions of the light beams into the same direction and then emit the light beams. Further, the illumination device 31 is provided with the cooling device 9 for cooling the light source devices 41. The cooling device 9 is provided with a plurality of cooling fans 91 (91A through 91D) corresponding respectively to the light source devices 41A through 41D.

Further, the first lamp unit 4A is provided with the light source device 41A and the light source device 41C, and the second lamp unit 4B is provided with the light source device 41B and the light source device 41D. The first lamp unit 4A and the second lamp unit 4B are disposed on the X-direction side and the opposite-direction side to the X direction, respectively, across the light path changing device 5 from each other.

### Configuration of Lamp Unit

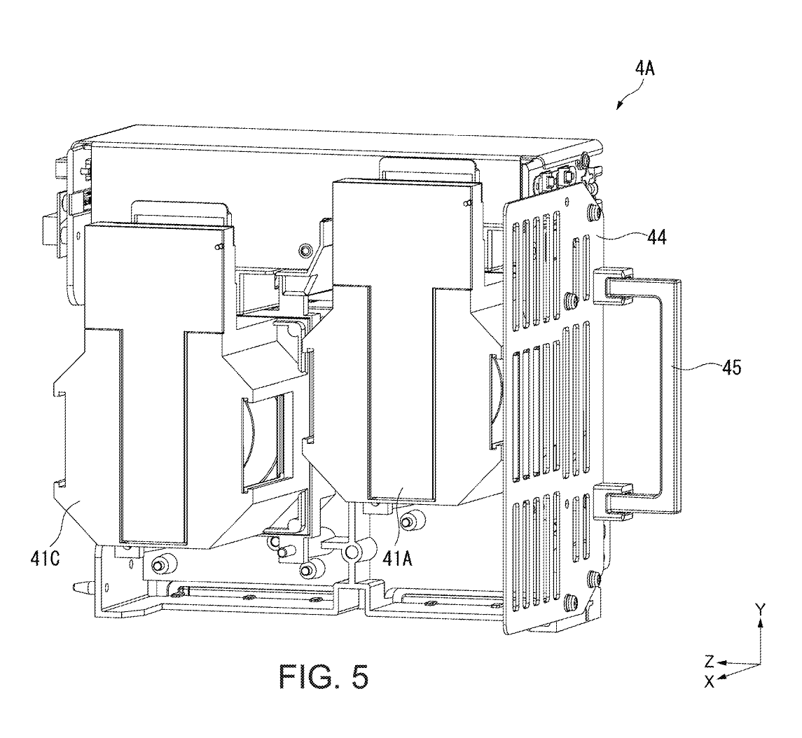

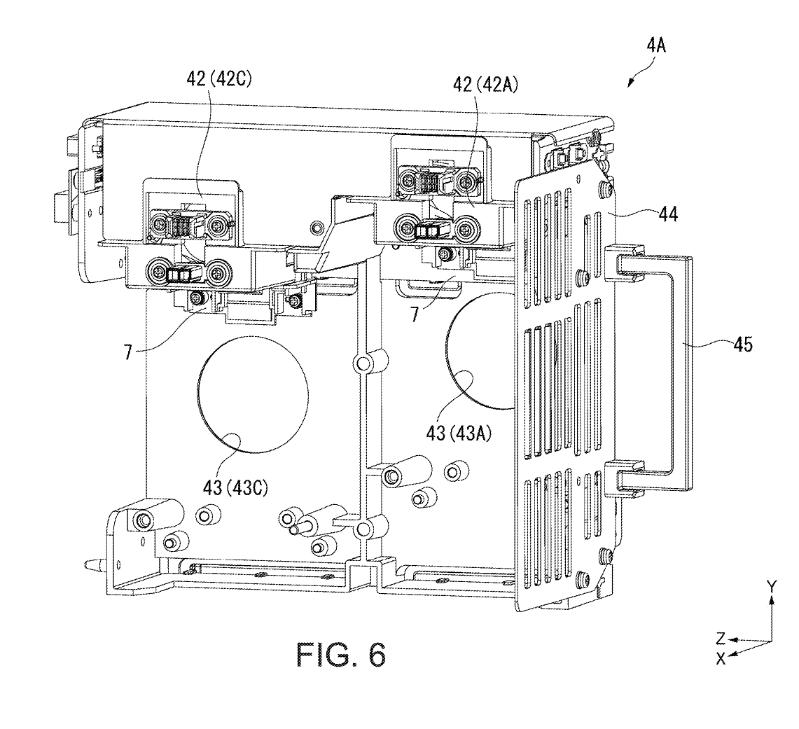

FIG. 5 is a perspective view of the first lamp unit 4A viewed from the X-direction side, and FIG. 6 is a perspective view of the first lamp unit 4A in the state in which the light source devices 41A, 41C are removed viewed from the X-direction side. It should be noted that since the first lamp unit 4A and the second lamp unit 4B have substantially the same configurations, only the first lamp unit 4A will hereinafter be described.

As shown in FIG. 5 and FIG. 6, the first lamp unit 4A is provided with connection parts 42, opening parts 43, a panel 44, a grip part 45, and flow dividing devices 7. Among these components, the connection parts 42 include a connection part 42A to which the light source device 41A is connected, and a connection part 42C to which the light source device 41C is connected as shown in FIG. 6. The connection part 42A is disposed on the opposite-direction side to the Z direction, and on the Y-direction side with respect to the connection part 42C. Further, the opening parts 43 include an opening part 43A for transmitting the light emitted from the light source device 41A and an opening part 43C for transmitting the light emitted from the light source device 41C. The connection part 42C is disposed on the opposite-direction side to the Z direction, and on the Y-direction side with respect to the opening part 43C similarly to the connection part 42A described above.

According to such a configuration, the light source device 41A is fixed to the first lamp unit 4A so as to be located on the opposite side to the Z-direction side and on the Y-direction side with respect to the light source device 41C, and the light source device 41C is fixed to the first lamp unit 4A so as to be located on the Z-direction side and on the opposite-direction side to the Y direction with respect to the light source device 41A. Further, the light beams emitted from the light source devices 41A, 41C are output toward the light path changing device 5 via the opening parts 43A, 43C, respectively.

Further, the panel 44 constitutes a surface on the opposite-direction side to the Z direction of the first lamp unit 4A, and to the surface on the opposite-direction side to the Z direction of the panel 44, there is attached the grip part 45 having a roughly U-shape and projected on the opposite-direction side to the Z direction from the surface. Thus, it is arranged that it is possible for the operator to remove the first lamp unit 4A from the projector 1 by pulling the grip part 45 toward the opposite-direction side to the Z direction.

### Configuration of Flow Dividing Device

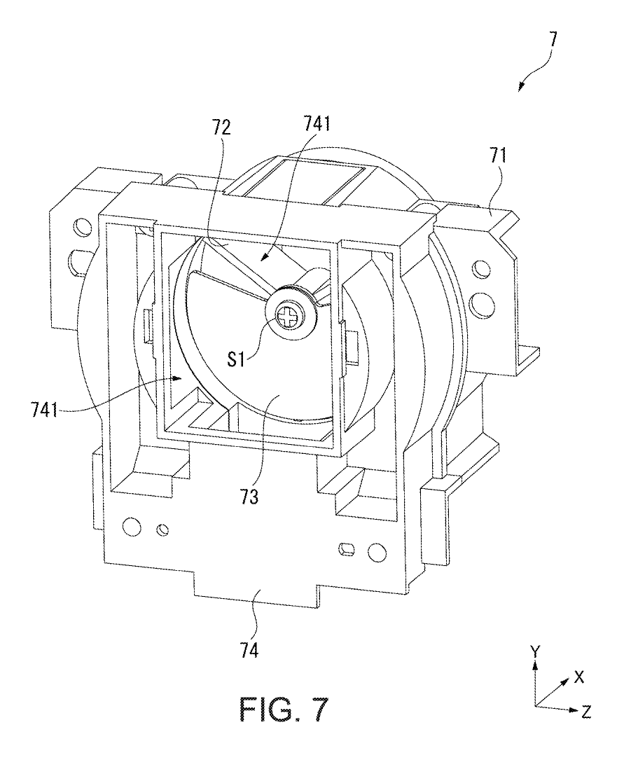

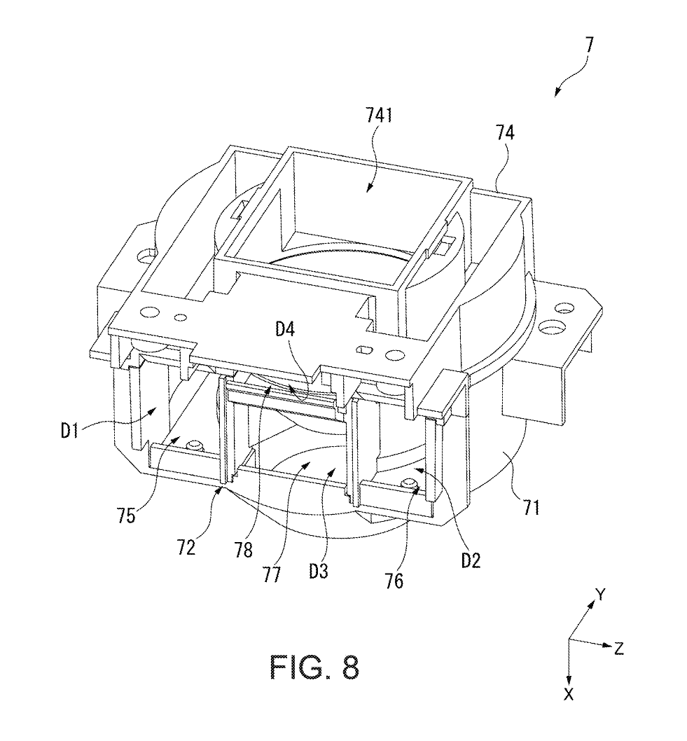

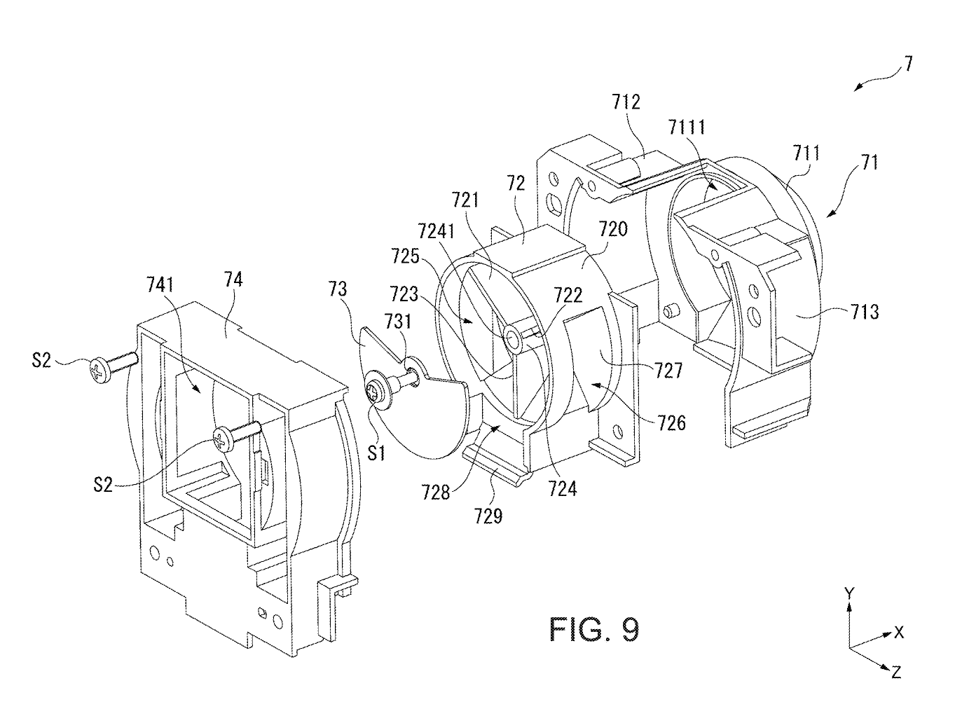

FIG. 7 is a perspective view of the flow dividing device 7 viewed from the opposite side to the X-direction side, FIG. 8 is a perspective view of the flow dividing device 7 viewed from the opposite-direction side to the Y direction, and FIG. 9 is an exploded perspective view of the flow dividing device 7. It should be noted that although the flow dividing device 7 is disposed for each of the light source devices 41A through 41D, since the configurations are the same, the flow dividing device 7 corresponding to the light source device 41A will be described in FIG. 7 through FIG. 9, and the following description.

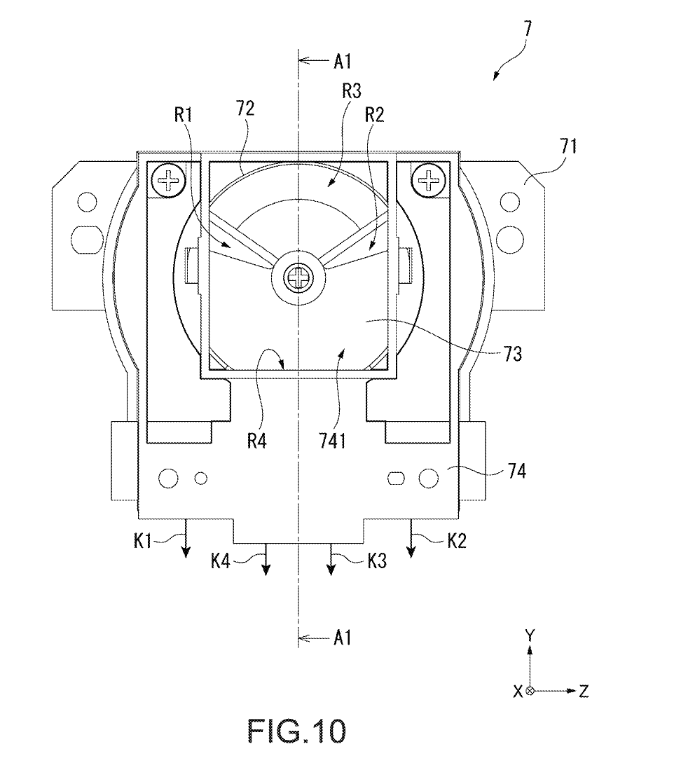

The flow dividing devices 7 are disposed in the first and second lamp units 4A, 4B so as to correspond respectively to the light source devices 41A through 41D, and each have a function of dividing the cooling gas supplied from the cooling fans 91A through 91D of the cooling device 9 described above to the flow dividing device 7. Specifically, the flow dividing device 7 is provided with a plurality of duct parts (first through fourth duct parts D1 through D4), and has a function of changing the flow amount of the cooling gas introduced into the inlet posts (first through third inlet ports R1 through R3) of the first through the third duct parts D1 through D3 among these duct parts (see FIG. 10). As shown in FIG. 7 through FIG. 9, the flow dividing device 7 is provided with a frame part 71, a flow dividing part 72, a rotary plate 73 and an inflow part 74, opening parts 75 through 78, the first duct part D1, the second duct part D2, the third duct part D3, and the fourth duct part D4.

### Configuration of Frame Part

As shown in FIG. 9, the frame part 71 constitutes an outer frame of the flow dividing device 7, and is provided with a bottom surface part 711, a left frame part 712, and a right frame part 713. The bottom surface part 711 is provided with a recessed part 7111 recessed in the X direction, and has a function of guiding the cooling gas having collided with the recessed part 7111 toward the opposite direction to the Y direction. Further, the left frame part 712 constitutes the first duct part D1 together with a cylindrical part 720 described later. In contrast, the right frame part 713 constitutes the second duct part D2 together with the cylindrical part 720 described above. Further, the bottom surface part 711 (the recessed part 7111) described above constitutes the third duct part D3 together with the cylindrical part 720 and a blocking part 727.

### Configuration of Flow Dividing Part

The flow dividing part 72 has a function of dividing the flow of the cooling gas supplied via the inflow part 74. As shown in FIG. 9, the flow dividing part 72 is provided with a cylindrical part 720, a first plate part 721, a second plate part 722, a third plate part 723, a central part 724, opening parts 725, 726, the blocking part 727, a recessed part 728, and a tilted part 729. Among these components, the first plate part 721, the second plate part 722, and the third plate part 723 each have a shape extending from the central part 724 provided with a hole part 7241 toward an inner side surface of the cylindrical part 720, and are disposed so as to divide the cylindrical part 720 into three parts. Specifically, the first plate part 721, the second plate part 722, and the third plate part 723 are disposed at intervals of about 120° centered on the central part 724. Therefore, when viewing the cylindrical part 720 described later from the X-direction side, an area surrounded by the first plate part 721 and the second plate part 722, an area surrounded by the second plate part 722 and the third plate part 723, and an area surrounded by the third plate part 723 and the first plate part 721 are set roughly the same in the area.

It should be noted that the tilted part 729 described above corresponds to a current guide part according to the invention.

In the outer peripheral surface of the cylindrical part 720, there is formed the opening part 725 in the area surrounded by the third plate part 723 and the first plate part 721, and there is formed the opening part 726 in the area surrounded by the second plate part 722 and the third plate part 723.

The blocking part 727 is disposed on the most X-direction side of the flow dividing part 72, and has a function of blocking the area (hereinafter referred to as the first inlet port R1 in some cases) surrounded by the third plate part 723 and the first plate part 721 when viewing the flow dividing part 72 from the X-direction side, and the area (hereinafter referred to as the second inlet port R2 in some cases) surrounded by the second plate part 722 and the third plate part 723 when viewing the flow dividing part 72 from the X-direction side. Thus, when the cooling gas is supplied to the first inlet port R1, the cooling gas flows out to the outside of the cylindrical part 720 via the opening part 725. Similarly, when the cooling gas is supplied to the second inlet port R2, the cooling gas flows out to the outside of the cylindrical part 720 via the opening part 726.

In contrast, since the blocking part 727 is not disposed in the area (hereinafter referred to as the third inlet port R3 in some cases) surrounded by the first plate part 721 and the second plate part 722, the cooling gas supplied to the third inlet port R3 flows toward the X-direction side, namely the frame part 71 side, via the inlet port R3.

Further, on the opposite-direction side to the Y direction on the outer peripheral surface of the cylindrical part 720, there is formed the recessed part 728, and the tilted part 729 is connected to the recessed part 728. The recessed part 728 constitutes a fourth inlet port R4 together with the inflow part 74 described later.

The tilted part 729 is a plate-like part, which is connected to an end part on the opposite side to the Y-direction side of the recessed part 728 described above, tilted from the base end side of the tilted part 729 toward the inflow part 74 side, and extends toward the opposite direction to the Y direction. In other words, the tilted part 729 is provided with a function of guiding flow of the cooling gas flowing from the fourth inlet port R4 described above toward the tilt direction described above.

### Configuration of Rotary Plate

The rotary plate 73 is a plate-like member having a roughly fan-like shape, and has a function of opening and closing a part of at least either of the first inlet port R1, the second inlet port R2, and the third inlet port R3. As shown in FIG. 7 through FIG. 9, the rotary plate 73 is rotatably fixed to the flow dividing part 72. Specifically, at roughly the center of the rotary plate 73, there is formed a hole part 731 with an inner diameter slightly larger than the inner diameter of a pin S1, and by fitting the pin S1 into the hole part 731 and the hole part 7241 of the central part 724 described above, the rotary plate 73 is fixed. Thus, the rotary plate 73 rotates under its own weight in accordance with the posture of the flow dividing device 7, furthermore, the projector 1 equipped with the first and second lamp units 4A, 4B each including the flow dividing device 7.

### Configuration of Inflow Part

The inflow part 74 is connected to the cooling fan 91 described above, and has a function of guiding the cooling gas, which has been supplied from the cooling fan 91, to the flow dividing part 72. The inflow part 74 is fixed to the frame part 71 with screws S2, and in a central area of the inflow part 74, there is formed an opening part 741 having a rectangular shape. Thus, the cooling gas having been supplied from the cooling fan 91 flows into the flow dividing part 72 via the opening part 741.

Further, the inflow part 74 constitutes the fourth duct part D4 together with the recessed part 728 and the tilted part 729 of the flow dividing part 72.

### Configuration of Opening Part

As shown in FIG. 8, the opening part 75 through the opening part 78 are formed on the opposite-direction side to the Y direction of the flow dividing device 7. Among these parts, the opening part 75 is located on the most opposite-direction side to the Z direction when viewing the flow dividing device 7 from the opposite-direction side to the Y direction, and allows the cooling gas flowing through the first duct part D1 to flow out to the outside of the flow dividing device 7. Further, the opening part 76 is located on the most Z-direction side when viewing the flow dividing device 7 from the opposite-direction side to the Y direction, and allows the cooling gas flowing through the second duct part D2 to flow out to the outside of the flow dividing device 7.

The opening part 77 and the opening part 78 are formed between the opening part 75 and the opening part 76 so as to be arranged side by side in the X direction. Among these parts, the opening part 77 is located on the X-direction side of the opening part 78 described above, and allows the cooling gas flowing through the third duct part D3 to flow out to the outside of the flow dividing device 7. In contrast, the opening part 78 is located on the opposite side to the X-direction side of the opening part 77 described above, and allows the cooling gas flowing through the fourth duct part D4 to flow out to the outside of the flow dividing device 7.

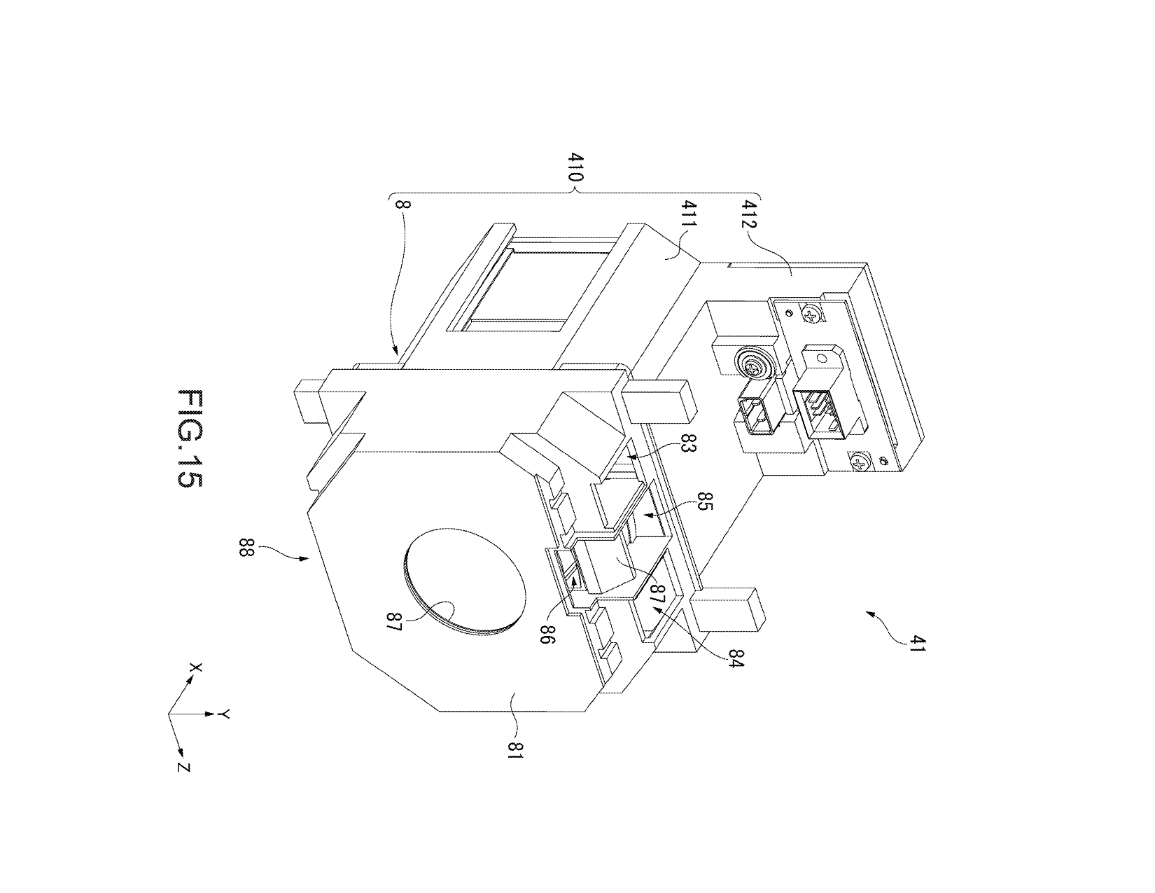

It should be noted that although described later in detail, the opening parts 75 through 78 are respectively connected to opening parts 83 through 86 (see FIG. 15) of the light source device 41, and the cooling gas is supplied to the light source device 41 through the opening parts 75 through 78.

### Flow Channels of Cooling Gas

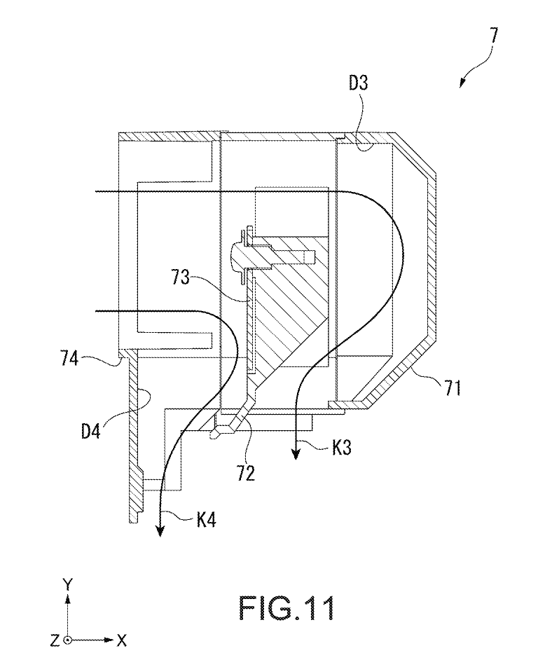

FIG. 10 is a front view of the flow dividing device 7, which is mounted on the installation surface such as an installation stand with the bottom surface part 22 side of the projector 1 located on the gravitational force direction side, and is therefore in a so-called normal mounting posture, viewed from the opposite-direction side to the X direction, and FIG. 11 is a cross-sectional view showing a cross-sectional surface along the line A1-A1 of the flow dividing device 7 in FIG. 10. It should be noted that in the following description, the cooling gas flowing into the inflow part 74 is defined as a cooling gas K, the cooling gas flowing through the first duct part D1 is defined as a cooling gas K1, the cooling gas flowing through the second duct part D2 is defined as a cooling gas K2, the cooling gas flowing through the third duct part D3 is defined as a cooling gas K3, and the cooling gas flowing through the fourth duct part D4 is defined as a cooling gas K4.

As described above, the cooling gas K flowing from the cooling fan 91 is divided and flows through the flow dividing device 7.

Here, in the case in which the projector 1 is in the normal mounting posture, the rotary plate 73 rotates under its own weight to block almost entire areas of the first inlet port R1 and the second inlet port R2 as shown in FIG. 10 and FIG. 11. Therefore, when the cooling gas K flows into the inside of the flow dividing device 7 via the inflow part 74, the cooling gas K is mainly guided to the third inlet port R3 of the third duct part D3 in the fully open state, and as shown in FIG. 11, the cooling gas K3 flows through the third duct part D3, and then flows out from the opening part 77. Further, since there is no chance for the fourth inlet port R4 of the fourth duct part D4 to be blocked by the rotary plate 73, some of the cooling gas K always flows into the fourth inlet port R4, and the cooling gas K4 flows through the fourth duct part D4 and then flows out from the opening part 78.

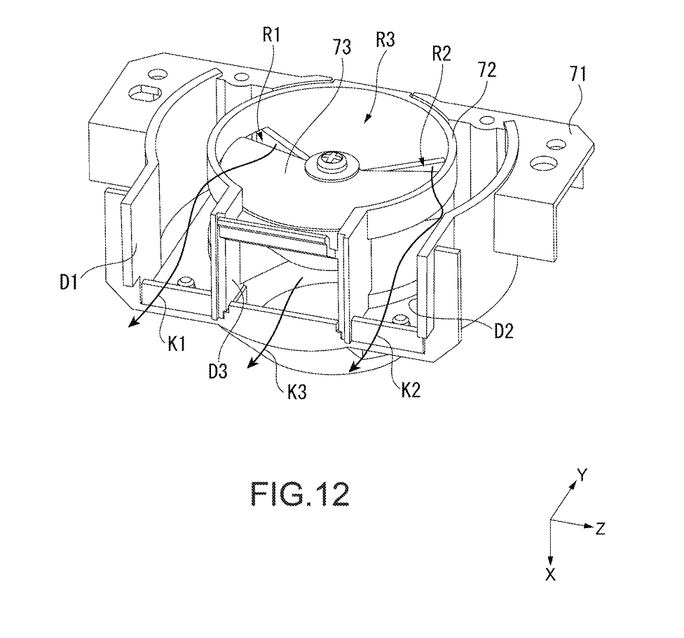

FIG. 12 is a perspective view showing the flow of the cooling gases K1, K2 flowing through the flow dividing device 7. It should be noted that in FIG. 12, in order to make the flow of the cooling gases K1, K2 flowing through the flow dividing device 7 easy to understand, there is shown the flow dividing device 7 in the state in which the inflow part 74 is removed.

Further, in the case in which the projector 1 is in the normal mounting posture described above, almost entire areas of the first inlet port R1 and the second inlet port R2 are blocked by the rotary plate 73. Therefore, the cooling gas K1 flowing into the first duct part D1 from a part of the first inlet port R1 flows through the first duct part D1 and then flows out from the opening part 75 as shown in FIG. 12. Similarly, the cooling gas K2 flowing into the second duct part D2 from a part of the second inlet port R2 flows through the second duct part D2 and then flows out from the opening part 76 as shown in FIG. 12.

As described above, in the case in which the projector 1 is in the normal mounting posture, the flow amount of the cooling gas K3 flowing through the third duct part D3 becomes larger than the flow amount of each of the cooling gases K1, K2 respectively flowing through the first duct part D1 and the second duct part D2.

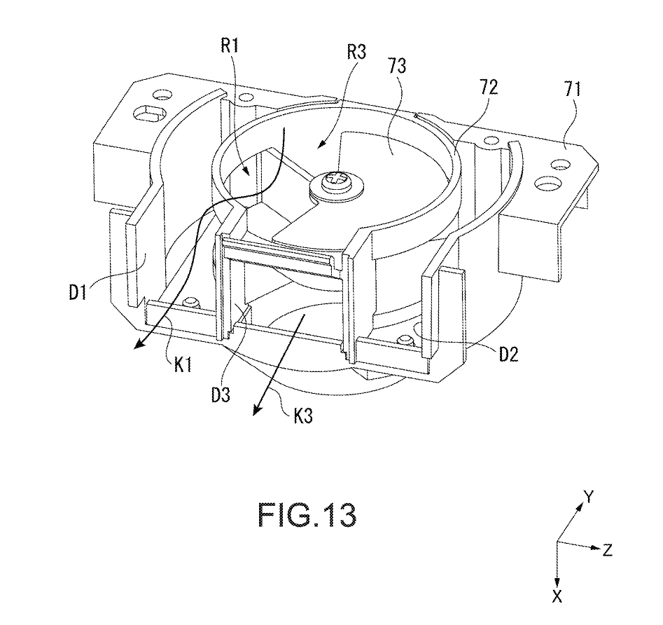

FIG. 13 is a perspective view showing the flow of the cooling gases K1, K3 flowing through the flow dividing device 7. It should be noted that FIG. 13 shows the flow dividing device 7 in the state in which the inflow part 74 is removed similarly to FIG. 12.

In the case in which the projector 1 is mounted in the state (hereinafter referred to as a downward posture in some cases) of rotating 90° counterclockwise viewed from the X-direction side from the normal mounting posture, the entire area of the inlet port R2 and almost entire area of the inlet port R3 are blocked by the rotary plate 73 as shown in FIG. 13. Therefore, when the cooling gas K flows into the inside of the flow dividing device 7 via the inflow part 74, the cooling gas K is mainly guided to the inlet port R1 of the first duct part D1 in the fully open state, and as shown in FIG. 13, the cooling gas K1 flows through the first duct part D1, and then flows out from the opening part 75. Further, since there is no chance for the fourth inlet port R4 of the fourth duct part D4 to be blocked by the rotary plate 73, some of the cooling gas K always flows into the fourth inlet port R4, and the cooling gas K4 flows through the fourth duct part D4 and then flows out from the opening part 78.

Further, the cooling gas K3 flowing into the third duct part D3 from the inlet port R3 flows through the third duct part D3 and then flows out from the opening part 77 as shown in FIG. 13.

As described above, in the case in which the projector 1 is in the downward posture described above, the flow amount of the cooling gas K1 flowing through the first duct part D1 becomes larger than the flow amount of the cooling gas K3 flowing through the third duct part D3.

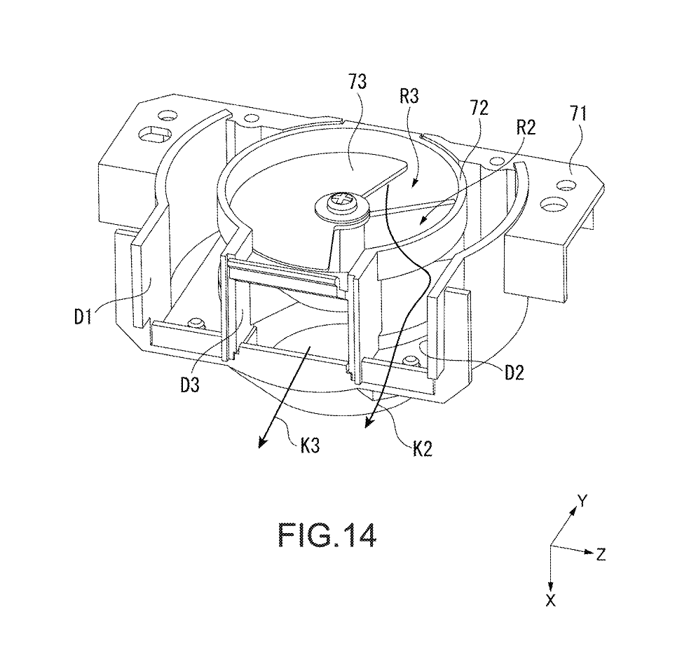

FIG. 14 is a perspective view showing the flow of the cooling gases K2, K3 flowing through the flow dividing device 7. It should be noted that FIG. 14 shows the flow dividing device 7 in the state in which the inflow part 74 is removed similarly to FIG. 12 and FIG. 13.

In the case in which the projector 1 is mounted in the state (hereinafter referred to as an upward posture in some cases) of rotating 90° clockwise viewed from the X-direction side from the normal mounting posture, the entire area of the inlet port R1 and almost entire area of the inlet port R3 are blocked by the rotary plate 73 as shown in FIG. 14. Therefore, when the cooling gas K flows into the inside of the flow dividing device 7 via the inflow part 74, the cooling gas K is mainly guided to the inlet port R2 of the second duct part D2 in the fully open state, and as shown in FIG. 14, the cooling gas K2 flows through the second duct part D2, and then flows out from the opening part 76. Further, since there is no chance for the fourth inlet port R4 of the fourth duct part D4 to be blocked by the rotary plate 73, some of the cooling gas K always flows into the fourth inlet port R4, and the cooling gas K4 flows through the fourth duct part D4 and then flows out from the opening part 78.

Further, the cooling gas K3 flowing into the third duct part D3 from the inlet port R3 flows through the third duct part D3 and then flows out from the opening part 77 as shown in FIG. 14.

As described above, in the case in which the projector 1 is in the upward posture described above, the flow amount of the cooling gas K2 flowing through the second duct part D2 becomes larger than the flow amount of the cooling gas K3 flowing through the third duct part D3. In other words, the projector 1 is configured so that the rotary plate 73 rotates in accordance with the mounting posture to thereby appropriately block the inlet ports R1 through R3, and furthermore, to make it possible to control the flow amount of the cooling gas flowing through each of the duct parts D1 through D3.

### Configuration of Light Source Device

FIG. 15 is a perspective view of the light source device 41. It should be noted that in FIG. 15, the explanation will be presented using the X direction, the Y direction, and the Z direction in the light source device 41A installed in the first lamp unit 4A.

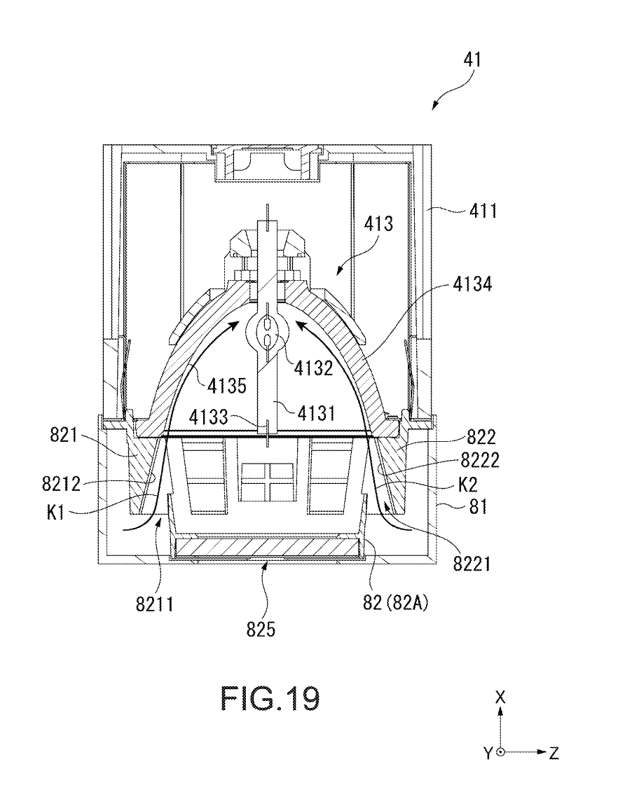

The light source device 41 (41A) is provided with a housing body 410 for housing a light source lamp 413 (see FIG. 19). The housing body 410 is provided with a first housing 411 and a second housing 8. To an end part on the Y-direction side of the first housing 411, there is fixed a mounting part 412 to be connected to the connection part 42A of the first lamp unit 4A described above. Further, the second housing 8 is connected so as to cover a surface on the opposite-direction side to the X direction of the first housing 411.

Inside the first housing 411, there is housed the light source lamp 413 described above having a light emitting tube 4131 and a reflector 4134. It should be noted that the configuration of the first housing 411 will be described later.

### Configuration of Second Housing

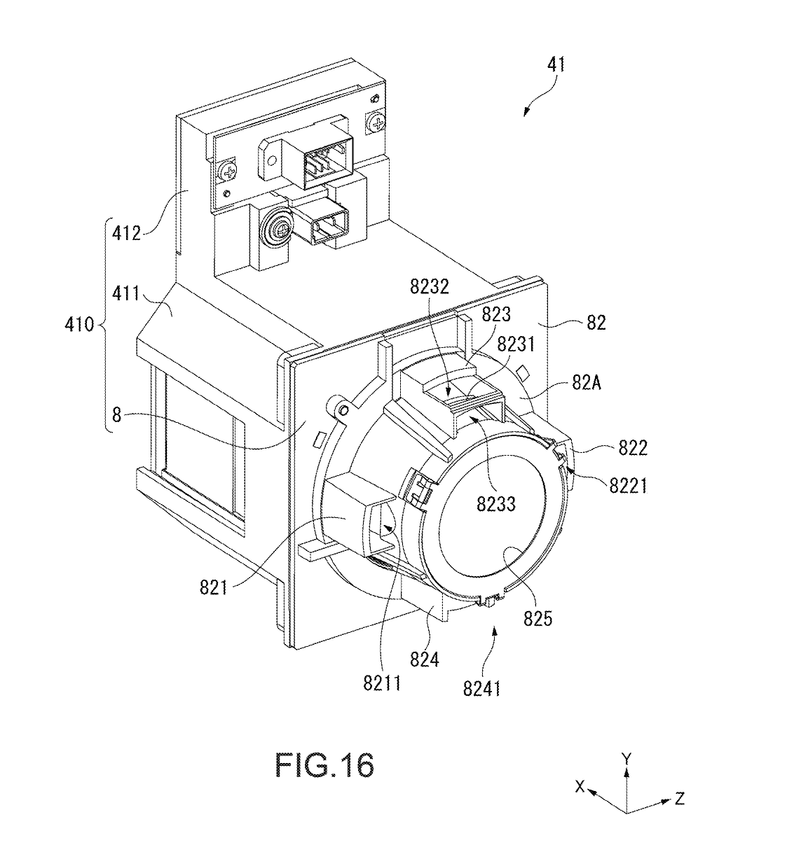

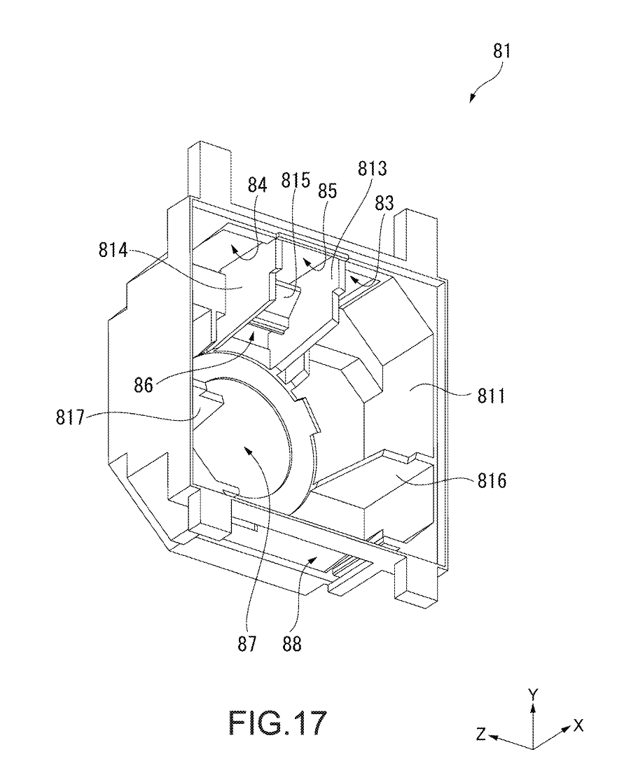

FIG. 16 is a perspective view showing the light source device 41 in the state in which a wind guide member 81 of the second housing 8 is removed, and FIG. 17 is a perspective view of the wind guide member 81 viewed from the opposite-direction side to the X direction.

As shown in FIG. 16 and FIG. 17, the second housing 8 is provided with the wind guide member 81, a cover member 82, the first opening part 83, the second opening part 84, the third opening part 85, the fourth opening part 86, an opening part 87, and an exhaust port 88.

Among these components, the first opening part 83, the second opening part 84, and the third opening part 85 are arranged along the Z direction in the end part on the Y-direction side of the second housing 8. Further, on the opposite-direction side to the X direction of the third opening part 85 disposed between the first opening part 83 and the second opening part 84, there is formed the fourth opening part 86.

It should be noted that to the opening parts 83 through 86, there are connected the opening parts 75 through 78 of the flow dividing device 7 described above, respectively. Therefore, the cooling gas having been divided by the flow dividing device 7 is supplied to the inside of the light source device 41 via the opening parts 83 through 86.

The opening part 87 is formed in roughly the central part of a surface located on the most opposite-direction side to the X direction of the second housing 8, and the light emitted from the light source lamp 413 is emitted toward the light path changing device 5 via the opening part 87.

The exhaust port 88 is provided to the surface on the opposite-direction side to the Y direction of the second housing 8, and has a function of discharging the cooling gas having flowed from the opening parts 83 through 86 described above and then flowed through the housing body 410.

### Configuration of Wind Guide Member

As shown in FIG. 17, the wind guide member 81 is provided with an outer frame part 811, vertical plate parts 813, 814, a current guide part 815, and horizontal plate parts 816, 817 in addition to the first through fourth opening parts 83 through 86 described above, the opening part 87, and the exhaust port 88. Among these components, the outer frame part 811 constitutes an outer frame of the wind guide member 81, and is formed to have a hollow shape. Further, the outer frame part 811 is provided with a plurality of hole parts for screwing not shown. By screwing screws not shown to the hole parts, the wind guide member 81 is fixed to the cover member 82.

Further, inside the outer frame part 811, there are formed the vertical plate parts 813, 814, the current guide part 815, and the horizontal plate parts 816, 817. Specifically, the vertical plate part 813 is a plate-like part extending toward the opposite-direction side to the Y direction from an area between the first opening part 83 and the third opening part 85. Further, the vertical plate part 814 is a plate-like part extending toward the opposite direction to the Y direction from an area between the second opening part 84 and the third opening part 85. The vertical plate parts 813, 814 each constitute a part of a fifth duct part D5, a sixth duct part D6, and a seventh duct part D7 described later.

The current guide part 815 has a function of guiding the cooling gas to either of a reflecting surface 4135 of the reflector 4134 described above and a tip part 4133 (see FIG. 19) of the light emitting tube 4131 together with a bent part 8231 described later. Specifically, the current guide part 815 is disposed between the vertical plate part 813 and the vertical plate part 814, and has a shape, which is tilted toward the opposite-direction side to the X direction from the base end side of the current guide part 815, and the tip part side of which extends toward the opposite direction to the Y direction, and the bent part 8231 described above is connected to the tip part side. The current guide part 815 and the bent part 8231 constitute a part of the seventh duct part D7 and an eighth duct part D8 described later.

The horizontal plate part 816 is a plate-like part formed in an intermediate part in the side surface on the opposite-direction side to the Z direction of the outer frame part 811. The horizontal plate part 816 constitutes a part of the fifth duct part D5 described later. Further, the horizontal plate part 817 is a plate-like part formed in an intermediate part in the side surface on the Z-direction side of the outer frame part 811. The horizontal plate part 817 constitutes a part of the sixth duct part D6 described later.

### Configuration of Cover Member

The cover member 82 has a function of covering the opposite-direction side to the X direction of the first housing 411. The cover member 82 is provided with a projection part 82A having a cylindrical shape and projecting toward the opposite-direction side to the X direction. As shown in FIG. 16, the projection part 82A is provided with a first inlet part 821, a second inlet part 822, a third inlet part 823, and an exhaust part 824. Among these parts, the first inlet part 821, the second inlet part 822, and the third inlet part 823 are disposed in a direction perpendicular to the central axis (the central axis along the X direction) of the light emitted from the light emitting tube 4131 of the light source lamp 413 in the projection part 82A, then reflected by the reflector 4134, and then emitted at intervals of 90°. Specifically, the first inlet part 821 is disposed on the opposite-direction side to the Z direction of the projection part 82A, and the second inlet part 822 is disposed at a position opposed to the first inlet part 821. Further, the third inlet part 823 is disposed between the first inlet part 821 and the second inlet part 822, namely on the most Y-direction side of the projection part 82A. Further, the exhaust part 824 is disposed at a position opposed to the third inlet part 823 in the projection part 82A.

The first inlet part 821 and the second inlet part 822 are respectively provided with an inlet port 8211 and an inlet port 8221, and the cooling gas described above flows into from the inlet ports 8211, 8221. In other words, the cooling gas is supplied to the light source lamp 413 housed in the first housing 411 via the inlet ports 8211, 8221.

The third inlet part 823 is provided with the bent part 8231 to be connected to the current guide part 815 inside the third inlet part 823. The bent part 8231 is a plate-like part tilted toward the opposite direction to the current guide part 815 described above. Further, the third inlet part 823 is provided with an inlet port 8232 on the Y-direction side, and is provided with the inlet port 8233 on the opposite-direction side to the X direction. The cooling gas described above flows into each of the inlet ports 8232, 8233. In other words, the cooling gas is supplied to the light source lamp 413 housed in the first housing 411 via the inlet ports 8232, 8233.

The exhaust part 824 is provided with an exhaust port 8241, and the cooling gas having cooled the light source lamp 413 is discharged from the exhaust port 8241. Specifically, the cooling gas flows into the first housing 411 from the inlet ports 8211, 8221, 8232, and 8233 described above, and the cooling gas is discharged from the exhaust port 8241 described above.

It should be noted that the inlet ports 8211, 8221, 8232, and 8233 correspond to a plurality of inlet ports according to the invention.

### Configuration of First Housing and Light Source Lamp

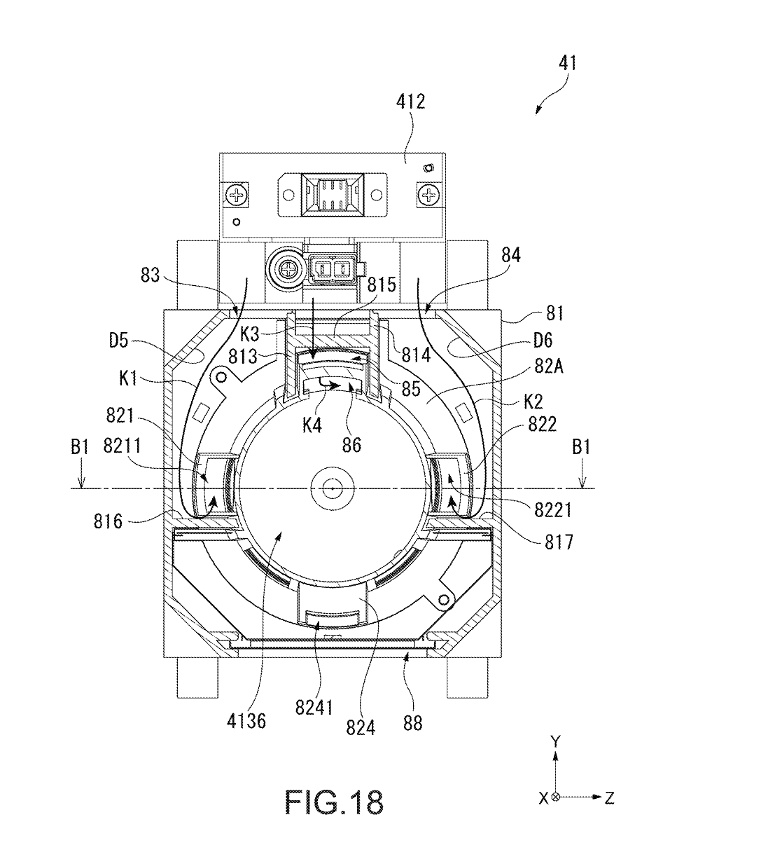

FIG. 18 is a cross-sectional view of the light source device 41 (the second housing 8) along the Y-Z plane, and FIG. 19 is a cross-sectional view showing a cross-sectional surface of the light source device 41 along the line B1-B1 in FIG. 18.

Here, before describing the flow channel of the cooling gas described above, the first housing 411 and the light source lamp 413 housed in the first housing 411 will be described. As shown in FIG. 19, the light source lamp 413 is provided with the light emitting tube 4131, and the reflector 4134 fixed to a sealing part located on the base end side of the light emitting tube 4131. Among these components, the reflector 4134 is for uniforming the light having been emitted from the light emitting part 4132 of the light emitting tube 4131 into one direction to emit the light thus uniformed, and is formed of an ellipsoidal reflector having the reflecting surface 4135 shaped like an elliptical surface in the present embodiment. Further, the surface on the opposite-direction side to the X direction of the first housing 411 is provided with an opening part 4136, which the light having been reflected by the reflecting surface 4135 of the reflector 4134, and the light directly input from the light emitting part 4132 pass through.

Further, the first inlet part 821 is connected to an end part on the opposite-direction side to the X direction of the reflector 4134. The first inlet part 821 is formed so that the dimension in a direction along the Z direction increases as proceeding toward the X-direction side. Therefore, the inner peripheral surface 8212 of the first inlet part 821 is continuous with the reflecting surface 4135 of the reflector 4134. Similarly, the second inlet part 822 is connected to an end part on the opposite-direction side to the X direction of the reflector 4134. The second inlet part 822 is formed so that the dimension in a direction along the Z direction increases as proceeding toward the X-direction side. Therefore, the inner peripheral surface 8222 of the second inlet part 822 is continuous with the reflecting surface 4135 of the reflector 4134.

### Flow Channels of Cooling Gas

Then, the flow channels of the cooling gases K1 through K4 divided by the flow dividing device 7 and then flow out from the opening parts 75 through 78 of the flow dividing device 7 will be described.

Firstly, as shown in FIG. 18, the cooling gas K1 inflowing from the opening part 75 described above flows through the fifth duct part D5, which is constituted by the surface on the X-direction side and the surface on the opposite-direction side to the Z direction of the wind guide member 81, the vertical plate part 813 and the horizontal plate part 816, and the surface on the opposite-direction side to the X direction of the cover member 82, toward the opposite-direction side to the Y direction. Then, the cooling gas K1 collides with the horizontal plate part 816 of the fifth duct part D5, and then flows into the inlet port 8211 of the first inlet part 821.

On the other hand, as shown in FIG. 18, the cooling gas K2 inflowing from the opening part 76 described above flows through the sixth duct part D6, which is constituted by the surface on the X-direction side and the surface on the Z-direction side of the wind guide member 81, the vertical plate part 814 and the horizontal plate part 817, and the surface on the opposite-direction side to the X direction of the cover member 82, toward the opposite-direction side to the Y direction. Then, the cooling gas K2 collides with the horizontal plate part 817 of the sixth duct part D6, and then flows into the inlet port 8221 of the second inlet part 822.

Then, the cooling gas K1 having flowed from the inlet port 8211 of the first inlet part 821 into the first housing 411 flows along the inner peripheral surface 8212 of the first inlet part 821 and the reflecting surface 4135 of the reflector 4134 continuous with the inner peripheral surface 8212. Meanwhile, the cooling gas K2 having flowed from the inlet port 8221 of the second inlet part 822 into the first housing 411 flows along the inner peripheral surface 8222 of the second inlet part 822 and the reflecting surface 4135 of the reflector 4134 continuous with the inner peripheral surface 8222. Therefore, the first inlet part 821 and the second inlet part 822 correspond to the wind guide part according to the invention.

Here, in the case in which the projector 1 is in the downward posture described above, since the position where the first inlet part 821 is disposed is located above the light source lamp 413, the upper side (the opposite-direction side to the Z direction) of the light emitting part 4132 is most likely to be heated to the highest temperature. In this case, since the flow amount of the cooling gas K1 flowing through the first duct part D1 is set to the largest by the flow dividing device 7, the cooling gas K1 is made to flow efficiently to the upper side of the light emitting part 4132.

On the other hand, in the case in which the projector 1 is in the upward posture described above, since the position where the second inlet part 822 is disposed is located above the light source lamp 413, the upper side (the Z-direction side) of the light emitting part 4132 is most likely to be heated to the highest temperature. In this case, since the flow amount of the cooling gas K2 flowing through the second duct part D2 is set to the largest by the flow dividing device 7, the cooling gas K2 is made to flow efficiently to the upper side of the light emitting part 4132.

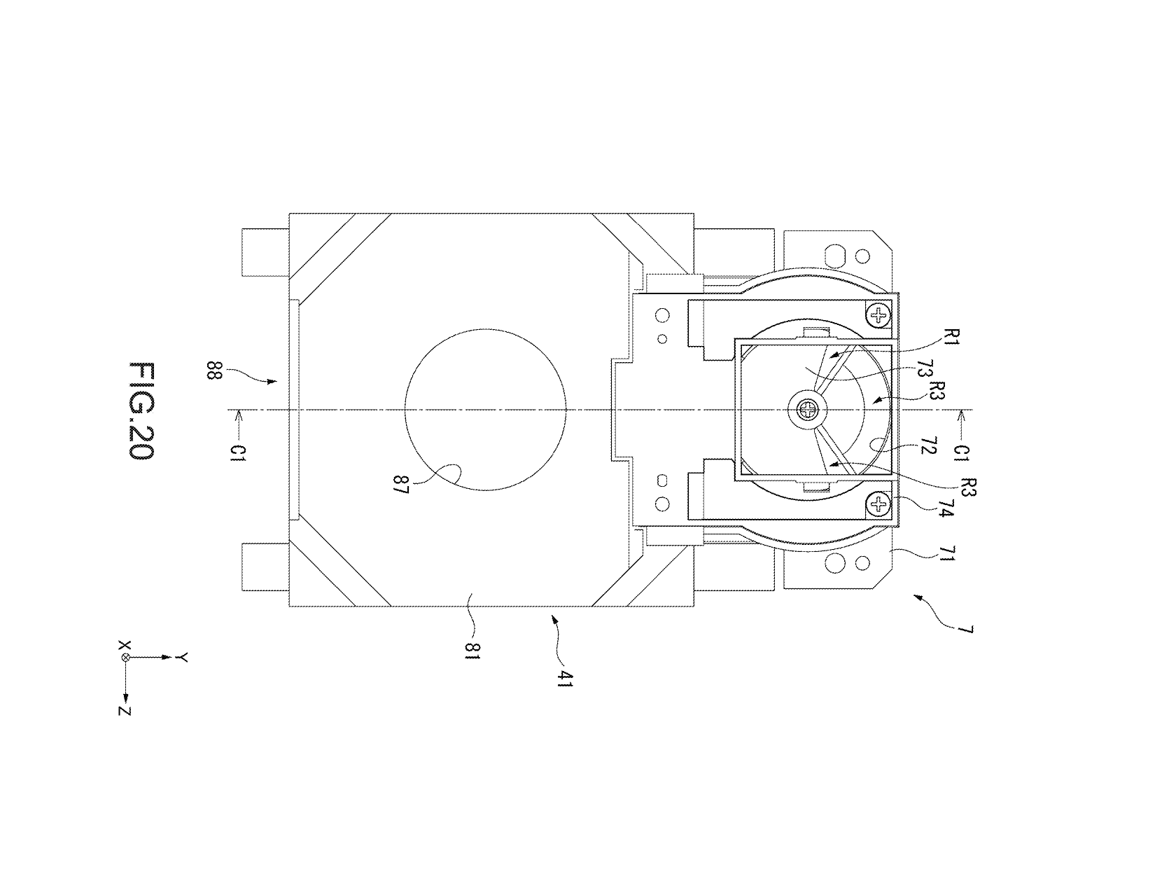

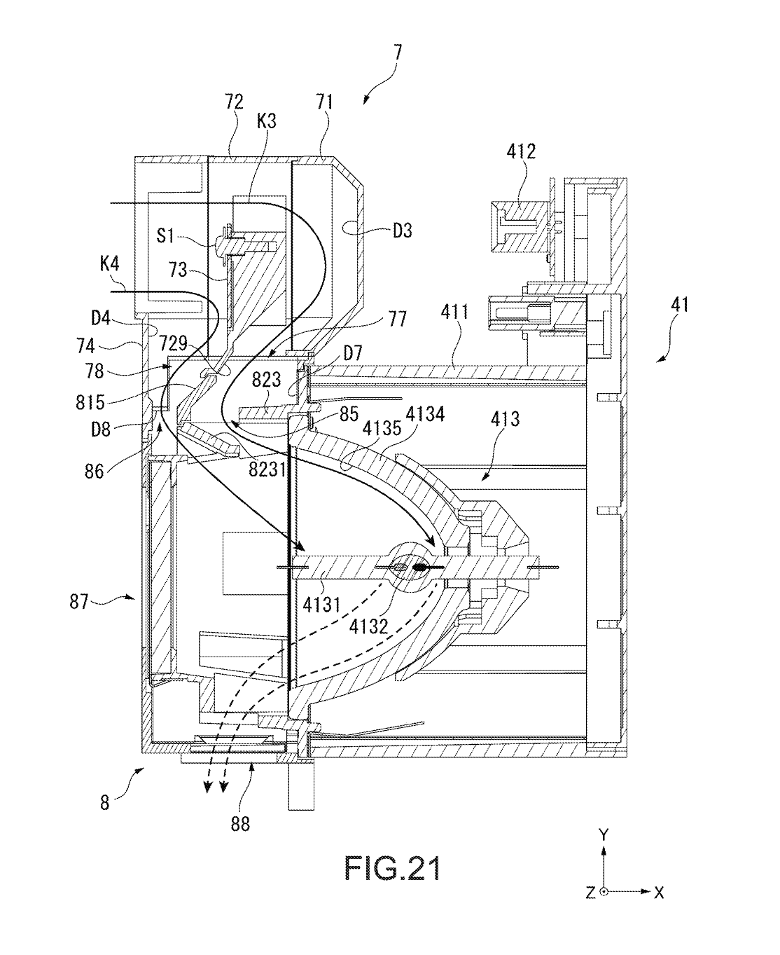

FIG. 20 is a plan view showing the state in which the flow dividing device 7 and the light source device 41 are connected to each other, and FIG. 21 is a cross-sectional view showing a cross-sectional surface along the line C1-C1 of the flow dividing device 7 and the light source device 41 shown in FIG. 20. It should be noted that FIG. 20 and FIG. 21 each show the flow dividing device 7 and the light source device 41 in the case in which the projector 1 is in the normal mounting posture.

As shown in FIG. 21, the cooling gas K3 inflowing from the opening part 77 via the third duct part D3 of the flow dividing device 7 flows through the seventh duct part D7, which is constituted by the vertical plate parts 813, 814 and the current guide part 815 of the wind guide member 81, and the third inlet part 823 and the bent part 8231 of the cover member 82, along a roughly L shape. Specifically, the cooling gas K3 flows from the third duct part D3 to the seventh duct part D7, and then collides with the bent part 8231 constituting the seventh duct part D7. Thus, the cooling gas K3 is changed in flow channel toward the reflector 4134 to form the roughly L shape, and flows into the first housing 411 along the reflecting surface 4135 of the reflector 4134. Therefore, the flow channel of the cooling gas K3 from the opening part 741 of the inflow part 74 to the reflector 4134 forms a roughly S shape viewed from the Z-direction side. It should be noted that the bent part 8231 also corresponds to the wind guide part according to the invention.

Here, in the case in which the projector 1 is in the normal mounting posture described above, since the position where the third inlet part 823 is disposed is located above the light source lamp 413, the upper side (the Y-direction side) of the light emitting part 4132 is most likely to be heated to the highest temperature. In this case, since the flow amount of the cooling gas K3 flowing through the third duct part D3 is set to the largest by the flow dividing device 7, the cooling gas K3 is made to flow efficiently to the upper side of the light emitting part 4132.

As shown in FIG. 21, the cooling gas K4 inflowing from the opening part 78 via the fourth duct part D4 of the flow dividing device 7 flows through the eighth duct part D8, which is constituted by the surface on the X-direction side of the inflow part 74, the surface on the X-direction side and the current guide part 815 of the wind guide member 81, and the bent part 8231 of the cover member 82, along a roughly L shape. Specifically, the cooling gas K4 flows from the fourth duct part D4 to the eighth duct part D8, and then collides with the surface on the X-direction side of the inflow part 74 constituting the eighth duct part D8. Thus, the cooling gas K4 is changed in flow channel toward the light emitting tube 4131 to form the roughly L shape, and flows into the first housing 411 along the bent part 8231. Therefore, the flow channel of the cooling gas K4 from the opening part 741 of the inflow part 74 to the tip part 4133 of the light emitting tube 4131 forms a roughly S shape viewed from the Z-direction side. The cooling gas K4 always flows to the tip part 4133 of the light emitting tube 4131 in either of the cases of the upward posture and the downward posture besides the case in which the projector 1 is in the normal mounting posture.

Since a lead wire is wound around the tip part 4133 although not shown in the drawings, the temperature of the tip part 4133 is apt to rise. In this case, since the cooling gas K4 always flows through the fourth duct part D4 due to the flow dividing device 7, the cooling gas K4 is made to efficiently flow to the tip part 4133 of the light emitting tube 4131.

In such a manner as described above, the cooling gas K flowing from the cooling fan 91 is controlled in the flow amount of each of the cooling gases K1 through K3 flowing into the first through third duct parts D1 through D3 by the flow dividing device 7 in accordance with the posture of the projector 1, and the cooling gases K1 through K3 with the flow amounts thus controlled and the cooling gas K4 flowing into the fourth duct part D4 are supplied to the light source device 41 to efficiently cool the light source device 41. Then, the cooling gases K1 through K4 having cooled the light source lamp 413 (the light emitting part 4132 and the tip part 4133) are discharged from the exhaust port 88 to the outside of the housing body 410 as indicated by the dotted line shown in FIG. 21.

According to the projector 1 related to the embodiment described above, the following advantages can be exerted.

Since the cooling gases K1 through K4 can be supplied to the inside of the housing body 410 (the first housing 411) in which the light emitting tube 4131 is housed from the respective directions different from each other, it is possible to cool the light emitting tube 4131 with the cooling gases K1 through K4 from the respective directions different from each other. Further, since the light source device 41 is not provided with the flow dividing device 7 for dividing the cooling gases K1 through K3 flowing into either of the inlet ports 8211, 8221, and 8232, the light source device 41 can be miniaturized.

Here, the upper side of the light emitting tube 4131 (the light emitting part 4132) is apt to be heated by the light emission compared to the lower side, and therefore, the temperature difference occurs between the upper side and the lower side. Such a localized temperature difference causes deterioration such as clouding or deformation of the glass constituting the light emitting tube 4131, and becomes a factor for shortening the life of the light emitting tube 4131. In contrast, according to the present embodiment, even in the case in which the posture of the light source device 41 (the projector 1) changes in a range from the normal mounting posture to the upward posture or the downward posture, since the cooling gases K1 through K3 can be supplied to the upper side of the light emitting tube 4131, the light emitting tube 4131 can effectively be cooled.

Since the end parts (the opening parts 83 through 86) of the fifth through eighth duct parts D5 through D8 to be connected to the inlet ports 8211, 8221, 8322, and 8323 are arranged side by side on the Y-direction side of the housing body 410, the cooling gases K1 through K4 to be supplied to the inlet ports 8211, 8221, 8322, and 8323 can be supplied from one direction (the Y-direction side). Therefore, compared to the case in which the end parts of the duct parts are arranged in two or more directions, the cooling gases K1 through K4 can efficiently be supplied, and at the same time, the light source device 41 can be miniaturized.

Since the cooling gas K3 is guided to the reflecting surface 4135 of the reflector 4134 by the current guide part 719 and the bent part 8231 constituting the seventh duct part D7 and the eighth duct part D8, the cooling gas K3 is supplied to the upper side of the light emitting part 4132 of the light emitting tube 4131 along the reflecting surface 4135 of the reflector 4134.

Further, since a lead wire is wound around the tip part 4133 of the light emitting tube 4131, the temperature of the tip part 4133 is apt to rise. In contrast, since in the present embodiment, the cooling gas K4 is guided to the tip part 4133 described above, the tip part 4133 can efficiently be cooled. Therefore, the cooling efficiency of the light source device 41 can be improved.

Since the cooling gases K1, K2 are guided to the reflecting surface 4135 of the reflector 4134 by the first inlet part 821 and the second inlet part 822, it is possible to supply the cooling gases K1, K2 to the upper side of the light emitting part 4132 of the light emitting tube 4131 along the reflecting surface 4135 of the reflector 4134. Thus, the cooling efficiency of the light source device 41 can be improved.

Further, since the first lamp unit 4A and the second lamp unit 4B are each provided with the flow dividing devices 7, the light source device 41 can surely be miniaturized, and furthermore, the illumination device 31 can be miniaturized compared to the case in which the flow dividing device 7 is provided to the light source device 41. Further, since the cooling gases K1 through K3 can selectively be supplied to the desired inlet ports 8211, 8221, and 8322 by the flow dividing device 7, the cooling gases K1 through K3 can surely be supplied to the upper part of the light emitting tube 4131 (the light emitting part 4132) in accordance with, for example, the posture of the illumination device 31 (the projector 1). Therefore, the upper part of the light emitting part 4132 of the light source device 41 can surely be cooled.

Further, since the light source device 41 can be miniaturized due to the configuration described above, the illumination device 31 equipped with the light source device 41, furthermore the projector 1, can be miniaturized. Further, since the light source device 41 can be miniaturized, the replacement operation and so on of the light source device 41 can be made easy.

### MODIFICATIONS OF EMBODIMENT

The invention is not limited to the embodiment described above, but includes modifications, improvements, and so on in the range where the advantages of the invention can be achieved.

In the embodiment described above, it is assumed that the housing body 410 is provided with the first housing 411 and the second housing 8. However, the invention is not limited to this configuration. For example, the housing body 410 can be integrated into a single unit.

Further, it is assumed that the inlet ports 8211, 8221, and 8232 are disposed in the direction perpendicular to the emission direction of the light emitted from the light source lamp 413 at intervals of 90°. However, the invention is not limited to this configuration. For example, it is also possible to dispose the inlet ports at intervals of 60°, or dispose the inlet ports at intervals of 30°. In this case, it is also possible that another inlet port is disposed in addition to the inlet ports 8211, 8221, and 8232.

In the embodiment described above, it is assumed that the end parts (the opening parts 83 through 86) of the fifth through eighth duct parts D5 through D8 to be connected to the inlet ports 8211, 8221, 8322, and 8323 are arranged side by side in the Y-direction side of the housing body 410. However, the invention is not limited to this configuration. It is also possible to dispose the opening parts in the vicinity of, for example, the inlet ports 8211, 8221, 8322, and 8323, respectively. Even in such a case, substantially the same advantages as in the light source device 41 described above can be obtained.

In the embodiment described above, it is assumed that the tilted part 729 and the bent part 8231 are provided. However, the invention is not limited to this configuration. For example, it is also possible to arrange that a member having the shape in which the tilted part 729 and the bent part 8231 are integrated is provided, or to eliminate such members. In other words, it is sufficient that the cooling gas K3 can be supplied to the reflecting surface 4135 of the reflector 4134 and the tip part 4133 of the light emitting tube 4131.

In the embodiment described above, it is assumed that the first inlet part 821 and the second inlet part 822 are formed so that the dimension in the direction along the Z direction increases as proceeding toward the X-direction side. However, the invention is not limited to this configuration. For example, it is also possible for the first inlet part 821 and the second inlet part 822 to be formed so that the dimension in the direction along the Z direction decreases as proceeding toward the X-direction side. In other words, it is sufficient for the first inlet part 821 and the second inlet part 822 to have a shape with which the cooling gases K1, K2 inflowing from the inlet ports 8211, 8221 of the first inlet part 821 and the second inlet part 822 are supplied along the reflecting surface 4135 of the reflector 4134.

In the embodiment described above, it is assumed that the first lamp unit 4A and the second lamp unit 4B are arranged across the light path changing device 5 from each other. However, the invention is not limited to this configuration. For example, it is also possible for the first and second lamp units 4A, 4B to be arranged in the Z direction on one side of the light path changing device 5, or to be arranged so as to be stacked in the Y direction.

In the embodiment described above, it is assumed that there are disposed the first lamp unit 4A and the second lamp unit 4B. However, the invention is not limited to this configuration. It is also possible to arrange that, for example, there is provided either one of the first lamp unit 4A and the second lamp unit 4B. Even in this case, since the flow dividing device 7 is disposed in either of the first lamp unit 4A and the second lamp unit 4B, the light source devices 41A through 41D can be miniaturized.

In the embodiment described above, it is assumed that the transmissive liquid crystal panels 341 (341R, 341G, and 341B) are used as the light modulation device. However, the invention is not limited to this configuration. It is also possible to use, for example, reflective liquid crystal panels instead of the transmissive liquid crystal panels 341 (341R, 341G, and 341B). In this case, it is also possible to perform color separation and color composition using the color combining device 344 without providing the color separation device 33.

In the embodiment described above, it is assumed that the projector 1 is equipped with the three liquid crystal panels 341 (341R, 341G, and 341B), but the invention is not limited to this configuration. Specifically, the invention can also be applied to a projector using two or less liquid crystal panels, or four or more liquid crystal panels.

Further, it is also possible to use a digital micromirror device or the like instead of the liquid crystal panels.

In the embodiment described above, it is assumed that the projector 1 is provided with the light source devices 41A through 41D. However, the invention is not limited to this configuration. For example, the number of the light source devices can be six, or eight.

In the embodiment described above, the image forming device 3 is configured to have a roughly U shape, but the invention is not limited to this configuration. For example, it is also possible to adopt an image forming device configured to have a roughly L shape.

What is claimed is:

1. A light source device comprising:
a light emitting tube including a light emitting part;
a reflector adapted to reflect light emitted from the light emitting tube;
a housing body adapted to house the light emitting tube and the reflector; and
a plurality of inlet ports adapted to guide a cooling gas to the light emitting tube from respective directions different from each other.

2. The light source device according to claim 1, wherein
the housing body includes
a first housing adapted to house the light emitting tube and the reflector, and
a second housing provided with the plurality of inlet ports, and
the inlet ports are disposed in a surface perpendicular to a central axis of a light beam emitted from the light source device so that a position of one of the inlet ports and a position of adjacent one of the inlet ports are 90° different from each other around the central axis.

3. The light source device according to claim 2, wherein
the second housing includes a plurality of duct parts respectively connected to the inlet ports, and
end parts of the duct parts located on an opposite side to a side to which the inlet ports are connected are arranged in a direction perpendicular to the central axis of the light beam.

4. The light source device according to claim 3, wherein
at least one of the duct parts includes
a current guide part adapted to guide the cooling gas, and
a bent part connected to the current guide part, and bending in a direction different from the current guide part, and
the current guide part and the bent part guide the cooling gas to at least either one of a reflecting surface of the reflector and a tip part of the light emitting tube.

5. The light source device according to claim 2, wherein
at least one of the inlet ports has a wind guide part adapted to guide the cooling gas to a reflecting surface of the reflector.

6. An illumination device comprising:
the light source device according to claim 1; and
a holding member adapted to hold the light source device,
wherein the holding member has a flow dividing device adapted to guide the cooling gas to at least one of the inlet ports.

7. An illumination device comprising:
the light source device according to claim 2; and
a holding member adapted to hold the light source device,
wherein the holding member has a flow dividing device adapted to guide the cooling gas to at least one of the inlet ports.

8. An illumination device comprising:
the light source device according to claim 3; and
a holding member adapted to hold the light source device,
wherein the holding member has a flow dividing device adapted to guide the cooling gas to at least one of the inlet ports.

9. An illumination device comprising:
the light source device according to claim 4; and
a holding member adapted to hold the light source device,
wherein the holding member has a flow dividing device adapted to guide the cooling gas to at least one of the inlet ports.

10. An illumination device comprising:
the light source device according to claim 5; and
a holding member adapted to hold the light source device,
wherein the holding member has a flow dividing device adapted to guide the cooling gas to at least one of the inlet ports.

11. A projector comprising:
the illumination device according to claim 6;
a light modulation device adapted to modulate light emitted from the illumination device;
a projection optical device adapted to project image based on the light modulated by the light modulation device; and
a cooling device adapted to supply the cooling gas.

12. A projector comprising:
the illumination device according to claim 7;
a light modulation device adapted to modulate light emitted from the illumination device;
a projection optical device adapted to project image based on the light modulated by the light modulation device; and
a cooling device adapted to supply the cooling gas.

13. A projector comprising:
the illumination device according to claim 8;
a light modulation device adapted to modulate light emitted from the illumination device;
a projection optical device adapted to project image based on the light modulated by the light modulation device; and
a cooling device adapted to supply the cooling gas.

14. A projector comprising:
the illumination device according to claim 9;
a light modulation device adapted to modulate light emitted from the illumination device;
a projection optical device adapted to project image based on the light modulated by the light modulation device; and
a cooling device adapted to supply the cooling gas.

15. A projector comprising:
the illumination device according to claim 10;
a light modulation device adapted to modulate light emitted from the illumination device;
a projection optical device adapted to project image based on the light modulated by the light modulation device; and
a cooling device adapted to supply the cooling gas.
